(19) United States
(12) Patent Application Publication
(10) Pub. No.: US 2026/0083993 A1
(43) Pub. Date: Mar. 26, 2026

(54) Vorrichtung zum Löschen zumindest eines Brandes im Freiland, insbesondere in waldreicher Umgebung

(71) Applicant: Walter MIELKE, Emden (DE)

(72) Inventor: Walter MIELKE, Emden (DE)

(21) Appl. No.: 18/897,705

(22) Filed: Sep. 26, 2024

(51) Int. Cl. A62C 3/02

(52) U.S. Cl. CPC A62C 3/025

(57) ABSTRACT

A device for extinguishing at least one fire on open land, in particular in well-wooded surroundings, includes at least one means for introducing at least one extinguishing medium into the source of the fire. The extinguishing medium is a shatterproof detonating device. The means for introducing at least one extinguishing medium may be a gun, a cruise missile, a plane, a drone or a different aircraft

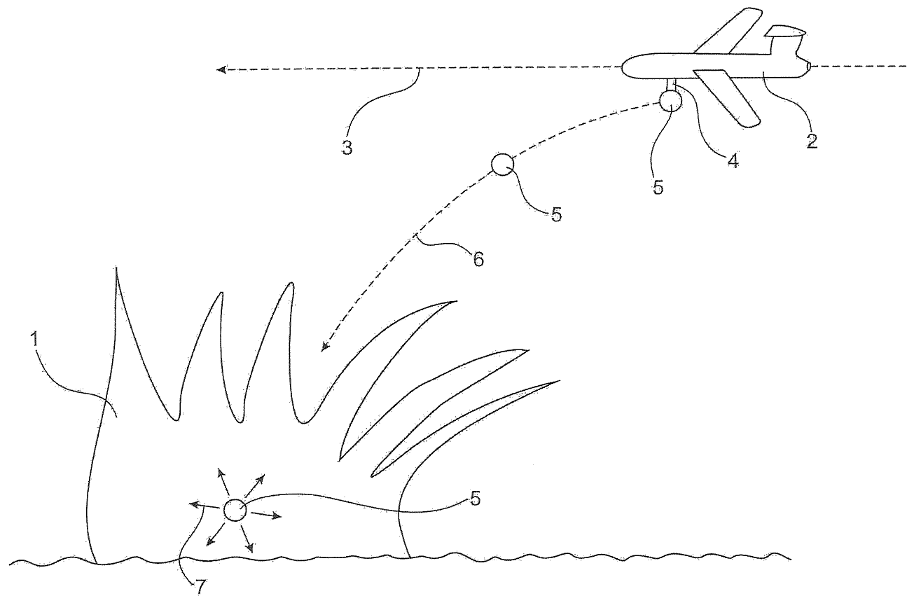

### FIELD OF THE INVENTION

The invention relates to a device for extinguishing at least one fire on open land, in particular in well-wooded surroundings, comprising at least one means for introducing at least one extinguishing medium into the source of the fire.

### BACKGROUND OF THE INVENTION

Large-area fires occur again and again on open land in particular during hotter summer months. These fires are in particular forest fires or peat fires. The extinguishing of these fires is difficult with conventional firefighting motor vehicles because it is not possible to reach the source of a fire of this type with these firefighting motor vehicles. Firefighting planes or also firefighting helicopters have thus been proposed in the prior art, by means of which extinguishing mediums can be released above the fire.

The extinguishing medium is often water, which partly already evaporates prior to hitting the fire source due to the high temperatures. The extinguishing of a larger forest fire is thus a lengthy undertaking because only little extinguishing medium can be introduced. Per flight, no larger extinguishing mediums (water/foam) can be transported, the accurate dropping thereof is additionally mainly determined by the individual ability of the pilots in consideration of strict safety aspects. Speed and flight height have to be dimensioned so generously that a risk to the airborne crew due to extremely high flames and heat is ruled out. The introduced quantities of water evaporate in a very short time especially in the case of the so-called “crown fires” with flames that are several meters high and most extreme heat far above the fire, without having made even just a slight impact.

### SUMMARY OF THE INVENTION

The invention is thus based on the object of specifying a device, by means of which an extinguishing of a fire on open land, in particular in well-wooded surroundings, is supported effectively.

This object is solved according to the invention in that the extinguishing medium is a shatterproof explosive device.

The introduction of an explosive device of this type into the source of a fire can lead to a detonation of the explosive device. This detonation or explosion, respectively, creates a shock wave, by means of which flames are blown out.

The device according to the invention thus does not introduce a liquid extinguishing medium into the source of the fire but an explosive device. Once the detonation has been triggered, the large flames, which are fed by trees, for example, are extinguished. Remaining smaller pockets of embers can then be fought with conventional fire extinguishing units. With regard to the performed detonation and the subsequent shock wave, it is important that all animals, which have no chance of escape or survival due to already more or less severe injuries, are killed immediately and thus saved from agonizing suffering.

The shatterproof explosive device provided according to the invention can be dimensioned so that the shock wave created by it is adapted to the concretely present fire on open land. The explosive device can thereby have the size of a soccer ball, for example, so that it can be handled well in this regard.

An explosive device of this type can be introduced, for example, with the help of a gun. Especially military guns can introduce explosive devices with high precision at certain points and thus also into the source of a fire.

However, the explosive device can also be fastened to a cruise missile, which introduces the explosive device into the source of the fire.

As in the prior art, however, planes, drones or other aircrafts can also be used in order to bring the explosive device into an area above the source of the fire. After a triggering of the explosive device, for example from a plane, and arming the explosive device, the aircraft can move away before the shock wave is then triggered in the source of the fire.

### BRIEF DESCRIPTION OF THE DRAWINGS

The SOLE FIGURE illustrates an exemplary embodiment of the present invention.

### DETAILED DESCRIPTION

One exemplary embodiment of the invention is illustrated in the drawing. The sole figure of the drawing shows a large fire 1 on open land in schematic side view. In the airspace, for instance above the large fire 1, a plane 2 is on its essentially straight flight path, which is clarified by means of the arrow 3.

The plane 2 carries a shatterproof explosive device 5 via a release means 4. The figure also shows the position of the explosive device 5 after a release. This explosive device 5 is on a parabolic trajectory, which is illustrated by means of the arrow 6. In further illustration, the explosive device 5 is introduced into the large fire 1, where it detonates. As clarified by means of the arrows 7, a shock wave is created thereby. This shock wave blows out the large fire 1.

1. A device for extinguishing at least one fire on open land, in particular in well-wooded surroundings, comprising at least one means for introducing at least one extinguishing medium into the source of the fire, wherein the extinguishing medium is a shatterproof detonating device.

2. The device according to claim 1, wherein the explosive device has the size of a soccer ball.

3. The device according to claim 1, wherein the means for introducing is a gun.

4. The device according to claim 1, wherein the means for introducing is a cruise missile.

5. The device according to claim 1, wherein the means for introducing is a plane a drone or a different aircraft.
